(19) United States
(12) Patent Application Publication
(10) Pub. No.: US 2015/0009415 A1
(43) Pub. Date: Jan. 8, 2015

(54) PROJECTED USER INTERFACE SYSTEM FOR MULTIPLE USERS

(71) Applicant: CANON KABUSHIKI KAISHA, Tokyo (JP)

(72) Inventors: Anna WONG, Randwick (AU); BEN YIP, Ryde (AU); CAMERON MURRAY EDWARDS, Clovelly (AU)

(21) Appl. No.: 14/322,779

(22) Filed: Jul. 2, 2014

(30) Foreign Application Priority Data
Jul. 4, 2013 (AU) 2013206685

(51) Int. Cl. H04N 5/74; G06F 3/0484

(52) U.S. Cl. CPC H04N 5/7408; G06F 3/0484
USPC 348/745; 715/746

(57) ABSTRACT

A method of projecting a user interface for a plurality of users with a calculated orientation is provided. The method detects gestures from the plurality of users associated with a projection of the user interface and applies a weighting, representing a level of interaction between a user and the user interface, to each of the detected gestures according to a gesture type and a context of the user interface when the gesture was detected, the context including consideration of positions of the plurality of users. An orientation of the user interface is calculated based on the weighting of the detected gestures and the context of the user interface, and the user interface is projected for the plurality of users with the calculated orientation.

### REFERENCE TO RELATED PATENT APPLICATION(S)

This application claims the benefit under 35 U.S.C. §119 of the filing date of Australian Patent Application No. 2013206685, filed Jul. 4, 2013, hereby incorporated by reference in its entirety as if fully set forth herein.

### TECHNICAL FIELD

The current invention relates to natural user interfaces, and in particular to orientation of a user interface for a plurality of users.

### BACKGROUND

Modern electronic devices, such as digital cameras, mobile phones and tablet computers, typically display a graphical user interface on a display panel that is part of the device. The size of such a display panel is limited by the physical size of the device. To improve usability, large graphical user interfaces that can be shared by multiple users simultaneously are preferred. One way to achieve this is to equip devices with an embedded projector which is capable of projecting a graphical user interface on to a surface near the device. However, when multiple users are sharing the device, the position of the projected user interface can be suboptimal for some users, because users are positioned at different orientations relative to the projected user interface. For example, users may be directly in front, to the right, to the left, or at any other orientation relative to the user interface. A superior device would automatically reorient its user interface relative to users to improve usability and to facilitate user interactions. In the case of multiple users, determining the optimal user interface orientation can be difficult, particularly if users are simultaneously interacting with the user interface.

One previous approach describes a touchscreen display device, where user interface elements are displayed at a default orientation relative to the device. At least one image is taken of a user interacting with the device. The images are used to determine the orientation of the user relative to the device. It is also determined whether the user is interacting with an element on the display. Subsequently, when the user is detected to be interacting with the display element, the orientation of the displayed element is then automatically adjusted according to the user's orientation relative to the device, from the initial default orientation. However, this approach does not handle multiple users interacting with the user interface simultaneously.

A second previous approach is for implementing a graphical interface with variable orientation. An application has an interface displayed in an initial orientation on a display. On receiving a request to open a second application, the system displays an interface of the second application at a different orientation to that of the first application. Orientation of the second interface is determined by location and direction of touch input from the user. Orientations of subsequent interfaces are determined in a hierarchical order from the orientation of the second interface.

A third previous approach uses a dynamically oriented user interface for an interactive display table. The user interface rotates around the perimeter of an interactive display table. When the user drags their finger on a part of the display table above a control in the user interface, the user interface moves clockwise or counter-clockwise, thus effectively reorienting the user interface. However, this approach does not deal with multiple users interacting with the user interface simultaneously. Additionally, the dynamic orientation of the user interface is not automatic, but user-controlled.

A fourth previous approach orientates information on a display with multiple users on different sides of the display. Each user has a unique totem, which is then used to locate and orient information appropriately to each user. However, this approach requires the use of a totem to determine user location and orientation, which is inconvenient and diminishes usability. As with previous approaches, the fourth approach also does not contain a method to resolve conflicting interactions.

It is therefore desirable to provide superior usability for scenarios where there are multiple users interacting simultaneously with a user interface.

### SUMMARY

According to one aspect of the present disclosure there is provided a method of projecting a user interface for a plurality of users with a calculated orientation. The method detects gestures from the plurality of users associated with a projection of the user interface, and applies a weighting, representing a level of interaction between a user and the user interface, to each of the detected gestures according to a gesture type and a context of the user interface when the gesture was detected, the context including consideration of positions of the plurality of users. An orientation of the user interface is calculated based on the weighting of the detected gestures and the context of the user interface, and the method projects the user interface for the plurality of users with the calculated orientation.

Desirably, the gesture type is any one or a combination of a hand gesture, a body gesture or a “null gesture”, representative of the presence of a user who is not detected to perform a recognisable gesture. The body gesture may be one of a user leaning forward, person approaching or leaving the user interface, proximity of user to the user interface. The hand gesture may comprise a fingertip gesture detected using a multi-layer training filter to ascertain an angle of the fingertip gesture. Preferably, the multi-layer training filter comprises a top layer that discriminates potential fingertip images from non-fingertip images. Advantageously the multi-layer training filer comprises at least one subsidiary layer having a plurality of fingertip images each associable with one potential fingertip image of the corresponding parent layer.

In a specific implementation, the context of the user interface is determined from at least one of: (i) content being presented by the user interface; (ii) a role of each user of the user interface; and (iii) a position of each user associated with the user interface. For example, the positions of users of the user interface are determined relative to a centre of the user interface using spherical coordinates. Alternatively or additionally, a position of a user is determined using face detection within an image captured by a camera associated with the detecting. In some implementations, the content is determined from a filename of an application being executed and reproduced by the user interface. Desirably a role of a user is determined from one of a presentation mode or an editing mode associated with the application being executed and reproduced by the user interface.

A further implementation comprises identification of the editing mode to assign a presenter role to at least one user and an audience role to at least one other user.

According to another aspect of the present disclosure there is provided a user interface apparatus comprising:

a computer having processor coupled to a memory, the memory storing a program executable by the processor to form a user interface by which plurality of users can interact with the interface;

at least one projector coupled to the computer configured to project an image of the user interface onto a surface;

at least one camera coupled to the computer and configured to detect gestures from the plurality of users associated with the image of the user interface;

the program comprising:

code for applying a weighting, representing a level of interaction between a user and the user interface, to each of the detected gestures according to a gesture type and a context of the user interface when the gesture was detected, the context including consideration of positions of the plurality of users;

code for calculating an orientation of the user interface based on the weighting of the detected gestures and the context of the user interface; and

code for causing the projector to project the user interface for the plurality of users with the calculated orientation.

Preferably the camera is an infrared camera, the apparatus further comprising an infrared light source for illuminating a projection area of the surface with infrared light for detection by the infrared camera in concert with interaction with the users.

A specific implementation further comprises at least one device configured to detect the context, said device including at least one of a range sensors, a light sensors, an omni-directional cameras, a microphone, a LIDAR device, and a LADAR devices, the context of the user interface being determined from at least one of:

(i) content being presented by the user interface;

(ii) a role of each user of the user interface; and

(iii) a position of each user associated with the user interface; and wherein positions of users of the user interface are determined relative to the centre of the user interface using spherical coordinates of a face detected within an image captured by the camera.

Desirably the content is determined from a filename of an application being executed and reproduced by the user interface and a role of a user is determined from one of a presentation mode or an editing mode associated with the application being executed and reproduced by the user interface, and identification of the editing mode to assign a presenter role to at least one user and an audience role to at least one other user.

The apparatus may further comprise a robotic arm coupled to the computer and upon which the projector is mounted, the robotic arm being controllable by the computer to cause the projectors to project the user interface for the plurality of users with the calculated orientation.

Preferably the gesture type is at least one a hand gesture, a body gesture, and a null gesture representative of the presence of a user who is not detected to perform a recognisable gesture, wherein the hand gesture comprises a fingertip gesture detected using a multi-layer training filter to ascertain an angle of the fingertip gesture, the multi-layer training filter comprising a top layer that discriminates potential fingertip images from non-fingertip images and at least one subsidiary layer having a plurality of fingertip images each associable with one potential fingertip image of the corresponding parent layer.

Other aspects are also disclosed, including a non-transitory computer readable storage medium having a program recorded thereon, the program being executable by a processor to perform the user interface method discussed above.

### BRIEF DESCRIPTION OF THE DRAWINGS

At least one embodiment of the present invention will now be described with reference to the following drawings, in which:

FIG. 1 is a high-level schematic block diagram representation of a user interface system according to the present disclosure;

FIG. 2 is a diagram illustrating a physical configuration of the user interface system of FIG. 1;

FIG. 3 is a top view diagram of users interacting with the user interface system of FIG. 1;

FIG. 4 shows a thumbnail view of the user interface, when the system is first started;

FIGS. 5A to 5D show four possible orientations of visual content displayed in full screen view;

FIG. 6 is a flow diagram of a method of projecting a user interface to users of the system of FIG. 1;

FIG. 7 depicts finger detection at an angle;

FIG. 8 depicts a process of deciding the azimuth angle of the users;

FIG. 9 schematically illustrates users interacting with the system;

FIG. 10 also schematically illustrates users interacting with the system;

FIG. 11 is a schematic plan view of users interacting with the system; and

FIGS. 12A and 12B form a detailed schematic block diagram of the system of FIG. 1 when implemented using a general purpose computer system.

### DETAILED DESCRIPTION INCLUDING BEST MODE

Described is a system and method for orienting a projected user interface to an optimal position for multiple users, using interaction gestures performed by users, while interacting with the user interface, to determine the orientation for the user interface. As will be described in more detail below, the orientation is also determined using a context in which the users interact with the user interface.

### Description of the System

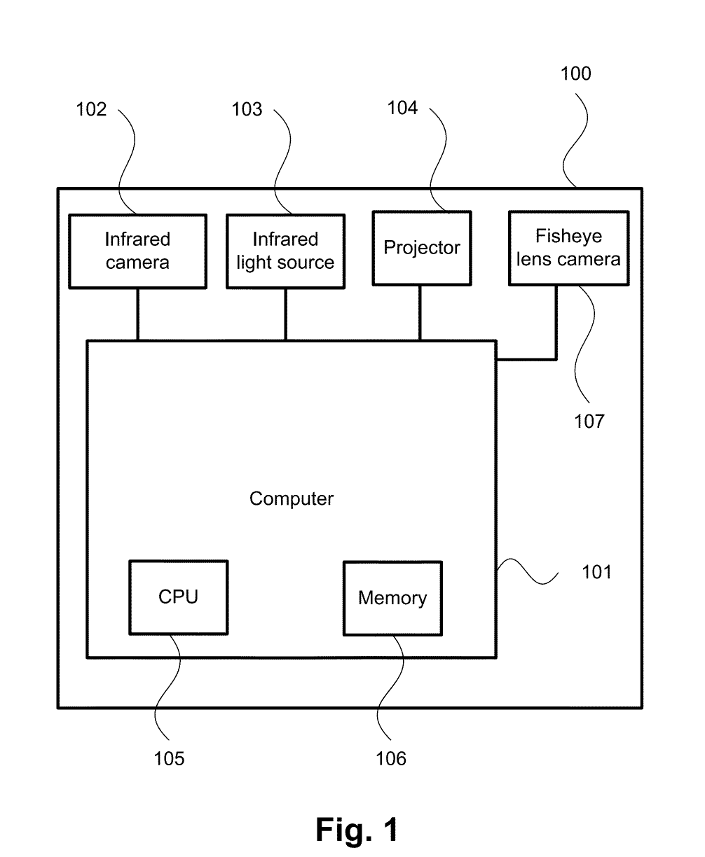

FIG. 1 shows a user interface system 100 having a computer 101 coupled to each of a camera 102, preferably operable in the infrared spectrum, a light source 103 complementing the camera 102 and therefore preferably operable to produce infrared light, a fisheye lens camera 107 and a projector 104. The computer 101 contains a memory 106 and a CPU 105.

Computer instructions for the operation of the user interface system are stored in the memory 106 and are executed by the CPU 106. The computer 101 stores and processes information received from the infrared camera 102 which senses light of wavelengths corresponding to the near infrared spectrum and does not sense light of wavelengths corresponding to the visible spectrum. The infrared light source 103 is typically formed by a light emitting diode (LED) source that emits infrared light of wavelengths that are detectable by the infrared camera 102. The projector 104 is capable of projecting a graphical user interface (GUI) onto a surface (not illustrated), such as a desk. The user interface system 100 may be configured to be placed on the surface, or the components thereof otherwise associated with the surface to facilitate the operation to be described. The projector 104 emits light of wavelengths corresponding to the visible spectrum and preferably emits no light of wavelengths corresponding to the near infrared spectrum that are captured by the infrared camera 102. This allows the light emitted by the projector 104 to operate independently of, and without interfering with, the infrared light source 103 and the infrared camera 102.

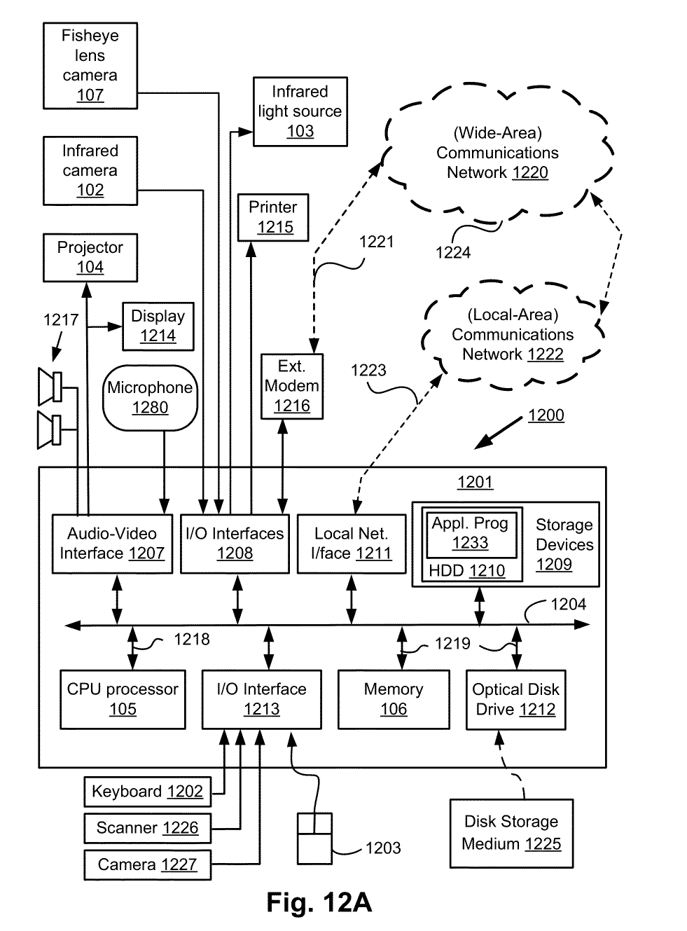

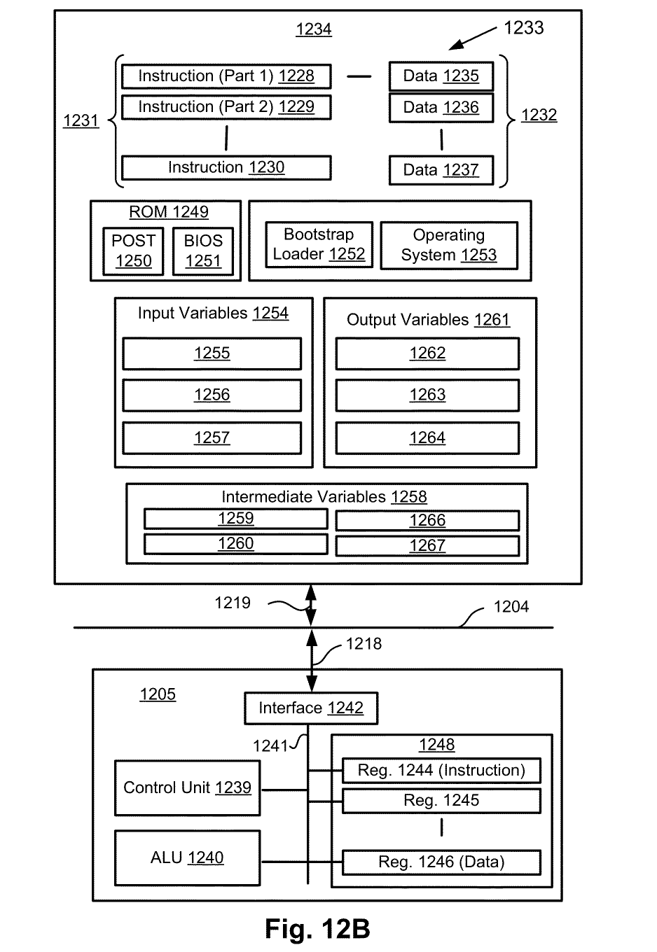

FIGS. 12A and 12B show further detail of the system 100 when configured as part of a general-purpose computer system 1200, upon which the various arrangements described can be practiced.

As seen in FIG. 12A, the computer system 1200 includes: a computer module 1201; input devices such as a keyboard 1202, a mouse pointer device 1203, a scanner 1226, a camera 1227, a microphone 1280, the infrared camera 102 and a fisheye lens camera 107; and output devices including a printer 1215, a display device 1214, loudspeakers 1217, the projector 104 and the infrared light source 103. An external Modulator-Demodulator (Modem) transceiver device 1216 may be used by the computer module 101 for communicating to and from a communications network 1220 via a connection 1221. The communications network 1220 may be a wide-area network (WAN), such as the Internet, a cellular telecommunications network, or a private WAN. Where the connection 1221 is a telephone line, the modem 1216 may be a traditional “dial-up” modem. Alternatively, where the connection 1221 is a high capacity (e.g., cable) connection, the modem 1216 may be a broadband modem. A wireless modem may also be used for wireless connection to the communications network 1220.

The computer module 1201 typically includes at least one processor unit 1205 implementing the CPU 105, and a memory unit 1206, representing part of the memory 106. For example, the memory unit 1206 may have semiconductor random access memory (RAM) and semiconductor read only memory (ROM). The computer module 1201 also includes an number of input/output (I/O) interfaces including: an audio-video interface 1207 that couples to the video display 1214, loudspeakers 1217 and microphone 1280; an I/O interface 1213 that couples to the keyboard 1202, mouse 1203, scanner 1226, camera 1227 and optionally a joystick or other human interface device (not illustrated); and an interface 1208 for the external modem 1216 and printer 1215. In some implementations, the modem 1216 may be incorporated within the computer module 1201, for example within the interface 1208. The computer module 1201 also has a local network interface 1211, which permits coupling of the computer system 1200 via a connection 1223 to a local-area communications network 1222, known as a Local Area Network (LAN). As illustrated in FIG. 12A, the local communications network 1222 may also couple to the wide network 1220 via a connection 1224, which would typically include a so-called “firewall” device or device of similar functionality. The local network interface 1211 may comprise an Ethernet circuit card, a Bluetooth™ wireless arrangement or an IEEE 802.11 wireless arrangement; however, numerous other types of interfaces may be practiced for the interface 1211.

The I/O interfaces 1208 and 1213 may afford either or both of serial and parallel connectivity, the former typically being implemented according to the Universal Serial Bus (USB) standards and having corresponding USB connectors (not illustrated). Storage devices 1209 also representative of part of the memory 106 are provided and typically include a hard disk drive (HDD) 1210. Other storage devices such as a floppy disk drive and a magnetic tape drive (not illustrated) may also be used. An optical disk drive 1212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1200.

The components 1205 to 1213 of the computer module 1201 typically communicate via an interconnected bus 1204 and in a manner that results in a conventional mode of operation of the computer system 1200 known to those in the relevant art. For example, the processor 1205 is coupled to the system bus 1204 using a connection 1218. Likewise, the memory 1206 and optical disk drive 1212 are coupled to the system bus 1204 by connections 1219. Examples of computers on which the described arrangements can be practiced include IBM-PC's and compatibles, Sun SPARCstations, Apple Mac™ or a like computer systems.

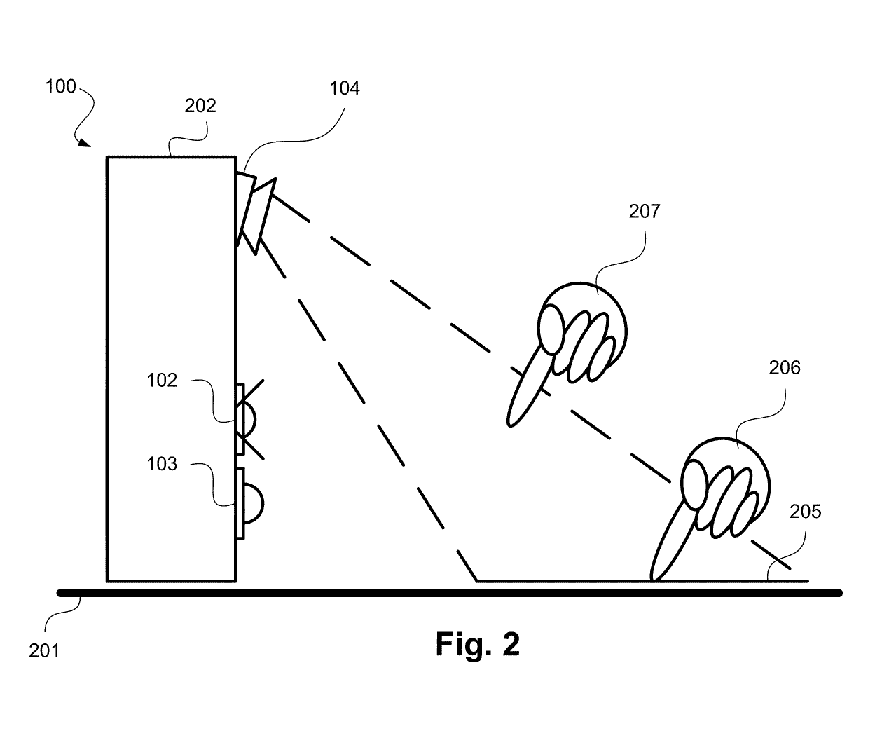

The user interface may be implemented using the computer system 1200 wherein the processes of FIGS. 2 to 11, to be described, may be implemented as one or more software application programs 1233 executable within the computer system 1200. In particular, the user interface processes are effected by instructions 1231 (see FIG. 12B) in the software 1233 that are carried out within the computer system 1200 in concert with the specific devices shown in FIG. 1. The software instructions 1231 may be formed as one or more code modules, each for performing one or more particular tasks. The software may also be divided into two separate parts, in which a first part and the corresponding code modules performs the user interface methods and a second part and the corresponding code modules manage a user interface between the first part and the user.

The software may be stored in a computer readable medium, including the storage devices described below, for example. The software is loaded into the computer system 1200 from the computer readable medium, and then executed by the computer system 1200. A computer readable medium having such software or computer program recorded on the computer readable medium is a computer program product. The use of the computer program product in the computer system 1200 preferably effects an advantageous apparatus for a projected user interface.

The software 1233 is typically stored in the HDD 1210 or the memory 1206. The software is loaded into the computer system 1200 from a computer readable medium, and executed by the computer system 1200. Thus, for example, the software 1233 may be stored on an optically readable disk storage medium (e.g., CD-ROM) 1225 that is read by the optical disk drive 1212. A computer readable medium having such software or computer program recorded on it is a computer program product. The use of the computer program product in the computer system 1200 preferably effects an apparatus for a projected user interface.

In some instances, the application programs 1233 may be supplied to the user encoded on one or more CD-ROMs 1225 and read via the corresponding drive 1212, or alternatively may be read by the user from the networks 1220 or 1222. Still further, the software can also be loaded into the computer system 1200 from other computer readable media. Computer readable storage media refers to any non-transitory tangible storage medium that provides recorded instructions and/or data to the computer system 1200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 1201. Examples of transitory or non-tangible computer readable transmission media that may also participate in the provision of software, application programs, instructions and/or data to the computer module 1201 include radio or infra-red transmission channels as well as a network connection to another computer or networked device, and the Internet or Intranets including e-mail transmissions and information recorded on Websites and the like.

The second part of the application programs 1233 and the corresponding code modules mentioned above may be executed to implement one or more traditional graphical user interfaces (GUIs) to be rendered or otherwise represented upon the display 1214. Through manipulation of typically the keyboard 1202 and the mouse 1203, a user of the computer system 1200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1217 and user voice commands input via the microphone 1280.

FIG. 12B is a detailed schematic block diagram of the processor 1205 and a “memory” 1234. The memory 1234 represents a logical aggregation of all the memory modules (including the HDD 1209 and semiconductor memory 1206) that can be accessed by the computer module 1201 in FIG. 12A, and is representative of the memory 106 of FIG. 1.

When the computer module 1201 is initially powered up, a power-on self-test (POST) program 1250 executes. The POST program 1250 is typically stored in a ROM 1249 of the semiconductor memory 1206 of FIG. 12A. A hardware device such as the ROM 1249 storing software is sometimes referred to as firmware. The POST program 1250 examines hardware within the computer module 1201 to ensure proper functioning and typically checks the processor 1205, the memory 1234 (1209, 1206), and a basic input-output systems software (BIOS) module 1251, also typically stored in the ROM 1249, for correct operation. Once the POST program 1250 has run successfully, the BIOS 1251 activates the hard disk drive 1210 of FIG. 12A. Activation of the hard disk drive 1210 causes a bootstrap loader program 1252 that is resident on the hard disk drive 1210 to execute via the processor 1205. This loads an operating system 1253 into the RAM memory 1206, upon which the operating system 1253 commences operation. The operating system 1253 is a system level application, executable by the processor 1205, to fulfil various high level functions, including processor management, memory management, device management, storage management, software application interface, and generic user interface.

The operating system 1253 manages the memory 1234 (1209, 1206) to ensure that each process or application running on the computer module 1201 has sufficient memory in which to execute without colliding with memory allocated to another process. Furthermore, the different types of memory available in the system 1200 of FIG. 12A must be used properly so that each process can run effectively. Accordingly, the aggregated memory 1234 is not intended to illustrate how particular segments of memory are allocated (unless otherwise stated), but rather to provide a general view of the memory accessible by the computer system 1200 and how such is used.

As shown in FIG. 12B, the processor 1205 includes a number of functional modules including a control unit 1239, an arithmetic logic unit (ALU) 1240, and a local or internal memory 1248, sometimes called a cache memory. The cache memory 1248 typically includes a number of storage registers 1244-1246 in a register section. One or more internal busses 1241 functionally interconnect these functional modules. The processor 1205 typically also has one or more interfaces 1242 for communicating with external devices via the system bus 1204, using a connection 1218. The memory 1234 is coupled to the bus 1204 using a connection 1219.

The application program 1233 includes a sequence of instructions 1231 that may include conditional branch and loop instructions. The program 1233 may also include data 1232 which is used in execution of the program 1233. The instructions 1231 and the data 1232 are stored in memory locations 1228, 1229, 1230 and 1235, 1236, 1237, respectively. Depending upon the relative size of the instructions 1231 and the memory locations 1228-1230, a particular instruction may be stored in a single memory location as depicted by the instruction shown in the memory location 1230. Alternately, an instruction may be segmented into a number of parts each of which is stored in a separate memory location, as depicted by the instruction segments shown in the memory locations 1228 and 1229.

In general, the processor 1205 is given a set of instructions which are executed therein. The processor 1205 waits for a subsequent input, to which the processor 1205 reacts to by executing another set of instructions. Each input may be provided from one or more of a number of sources, including data generated by one or more of the input devices 1202, 1203, data received from an external source across one of the networks 1220, 1202, data retrieved from one of the storage devices 1206, 1209 or data retrieved from a storage medium 1225 inserted into the corresponding reader 1212, all depicted in FIG. 12A. The execution of a set of the instructions may in some cases result in output of data. Execution may also involve storing data or variables to the memory 1234.

The disclosed user interface arrangements use input variables 1254, which are stored in the memory 1234 in corresponding memory locations 1255, 1256, 1257. The user interface arrangements produce output variables 1261, which are stored in the memory 1234 in corresponding memory locations 1262, 1263, 1264. Intermediate variables 1258 may be stored in memory locations 1259, 1260, 1266 and 1267.

Referring to the processor 1205 of FIG. 12B, the registers 1244, 1245, 1246, the arithmetic logic unit (ALU) 1240, and the control unit 1239 work together to perform sequences of micro-operations needed to perform “fetch, decode, and execute” cycles for every instruction in the instruction set making up the program 1233. Each fetch, decode, and execute cycle comprises:

(i) a fetch operation, which fetches or reads an instruction 1231 from a memory location 1228, 1229, 1230;

(ii) a decode operation in which the control unit 1239 determines which instruction has been fetched; and

(iii) an execute operation in which the control unit 1239 and/or the ALU 1240 execute the instruction.

Thereafter, a further fetch, decode, and execute cycle for the next instruction may be executed. Similarly, a store cycle may be performed by which the control unit 1239 stores or writes a value to a memory location 1232.

Each step or sub-process in the processes of FIGS. 2 to 11 is associated with one or more segments of the program 1233 and is performed by the register section 1244, 1245, 1247, the ALU 1240, and the control unit 1239 in the processor 1205 working together to perform the fetch, decode, and execute cycles for every instruction in the instruction set for the noted segments of the program 1233.

### Description of the System—Camera

The purpose of the camera 102 is to enable the system 100 to be able to identify pointing devices, such as hands or fingers of the user, or a pen held in the fingers of the user. Each pointing device must be identified in image frames captured by the camera 102 to allow pointing devices to be tracked over time. Additionally, the pointing devices need to be locatable amongst any background noise present in the environment in which the user interface system 100 is operating. This would be especially true where the camera 102 is configured to operate in the visible light spectrum. If visible light was being captured by the camera 102, then the pointing device would need to be tracked through changing lighting conditions, especially when placed inside an area of operation of the projector 104. The positioning of the camera 102 relative to other components in the user interface system 100 will be described in more detail below, however the camera 102 may be wearable, mounted on the ceiling, the wall, on the desk, or near the projector 104, depending on the size and type of device used.

The camera 102 may also be used to detect information about a context in which the users interact with the user interface system 100, such as detecting positions of the users relative to the user interface system 100. The infrared camera 102 has a limited angle of view. To capture a wider range of context, various types of devices may be used to detect context information. For example, context information may be detected using range sensors, light sensors, omni-directional cameras, microphones, LIDAR (light detection and ranging) devices or LADAR (laser detection and ranging) devices. Such context detecting devices could be wearable, or mounted on the ceiling, the wall, on the desk, or near the projector.

As will be described in more detail below, the infrared camera 102 is used to detect gestures being performed by users of the system 100.

The purpose of the infrared light source 103 is to illuminate pointing devices, such as hands or fingers of the user, such that the pointing devices appear in the image captured by the camera 102. The brightness of each pointing device in the captured image is determined by the distance of each pointing device from the infrared light source 103. The brightness of each pointing device is used to determine distance information used to detect gestures. While the infrared camera 102 and infrared light source 103 are used to determine distance information and to detect gestures, other types of cameras and hardware detection devices could, alternatively, be used. For example, gestures may be detected using stereo cameras, time-of-flight cameras, or cameras used in combination with structured illumination.

The purpose of the fisheye lens camera 107 is to capture the context surrounding the device, such as the positions of the users.

### Description of the System—Configuration

FIG. 2 illustrates one physical arrangement of the user interface system 100 consistent with a preferred implementation. Here, the user interface system 100 is configured within a housing 202 which rests or is otherwise positioned on a flat horizontal surface 201, such as a desk. The user interface system 100 includes the infrared camera 102 and the infrared light source 103 mounted below the projector 104. The projector 104 projects a graphical user interface (GUI) 205 on to the surface 201. Two hands 206 and 207 of a user interact with the GUI 205 by pointing at and touching content within the GUI 205. Unlike a conventional interaction between a mouse-enabled GUI displayed on a monitor, such as would be appreciated from use of the mouse 1203 and display 1214 in a traditional GUI environment, the interaction between a hand 206 and the GUI 205 may occur on the surface 201 or in the space above the GUI 205. The infrared light source 103 illuminates objects in the vicinity of the graphical user interface 205 where users interact with the user interface. The infrared camera 102 is positioned close to an infrared light source 103 so that the field of view of the camera 102 includes the graphical user interface 205 and the region around it where users may interact with the graphical user interface 205.

In configuration illustrated in FIGS. 1 and 2, the user interface system 100 may be implemented as a stand-alone apparatus, for example able to be coupled to a computing network (e.g. 1220, 1222) or coupled to a stand-alone computer, and to operate as an alternative to a traditional mouse-enable GUI. In the arrangement illustrated in FIG. 12A, the CPU 105 and memory 106 of the system 100 are coincident with the processor 1205 and memory 1206/1210 of the computer module 1201, whereas the components 102, 103 and 104 are coupled to the computer module 1201.

### Function

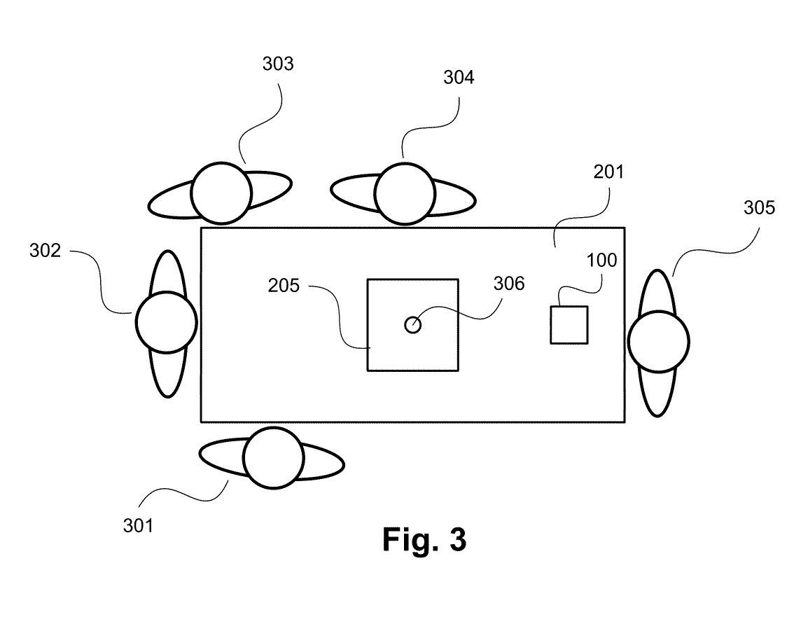

One purpose of the described system 100 is to share visual content amongst a group of proximate users. FIG. 3 shows a top view of an implementation where five users 301-305 are interacting with GUI implemented using the system 100. The users are positioned around a user interface 205 which is centred at a centre position 306. The user interface 205 is projected onto the surface 201 of a table by the user interface system 100, seen in this example positioned on the surface 201 of the table. The content projected by the projector 104 can be most varied and could range from holiday photos to business presentations, or even architectural blueprints. Any of the users 301-305 can interact with the user interface 205 using their hands 206. As users may approach the table from all angles, it is inevitable that some users may view the content represented in the projected UI 205 upside down. It is therefore advantageous to determine the orientation of the user interface 205, to best facilitate the collective users' tasks.

Whilst all users may simultaneously view the user interface 205, the orientation of the user interface 205 could depend on the gestures of one or more of the users. For example, in the application of photo viewing, the user interface 205 is desirably directed to the user who is touching or otherwise gesturing or engaging with the user interface 205. The methods disclosed herein operate to determine the orientation of the user interface 205 even when there is a conflict among the interaction of users. For example, when two users are both touching the user interface 205, the system can decide the orientation based on their respective roles.

The optimal orientation does not always correspond to the direction of the user currently controlling the user interface. For example, in a business presentation, the content should be oriented towards the clients, while an architectural blueprint may be aligned with the North direction independent of where the users are. If the users are not happy with the suggested optimal orientation, they can manually re-orientate the user interface.

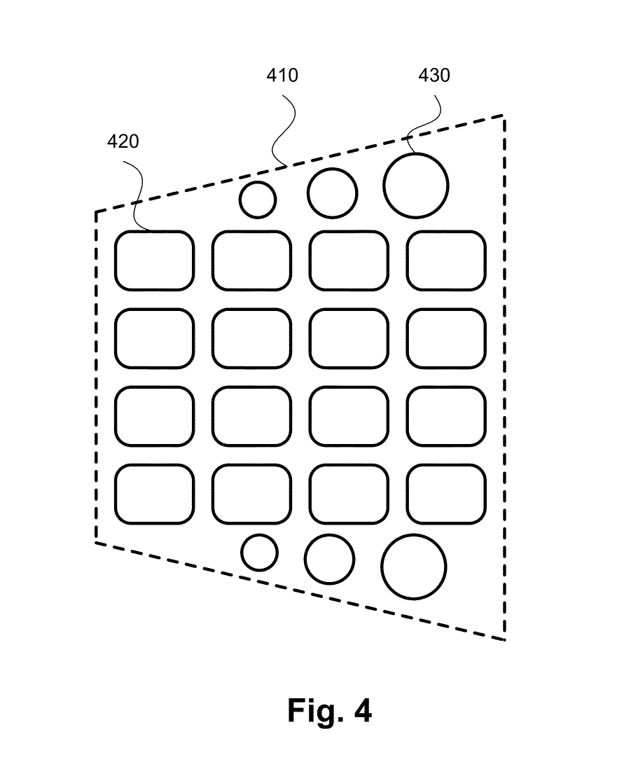

FIG. 4 shows a thumbnail view of the user interface 205 as observed from above the desk surface 201. This view is displayed by the system 100 when the system 100 is first powered-on. The trapezium 410 shows a bounding region of the user interface 205. This region is limited by the angle of projection of the projector 104 and the angle of view of the camera 102. Thumbnail images 420 in the user interface 205 represent visual content that can be displayed by the system 100. The circles 430 depict functional buttons allowing users to manage content, access help information etc. These buttons are usually hidden. When a user touches a thumbnail 420, for example, using their finger, the visual content associated with the thumbnail is displayed in a “full-screen” view. In full-screen view, visual content is displayed so that it occupies a large or significant portion of the user interface 205.

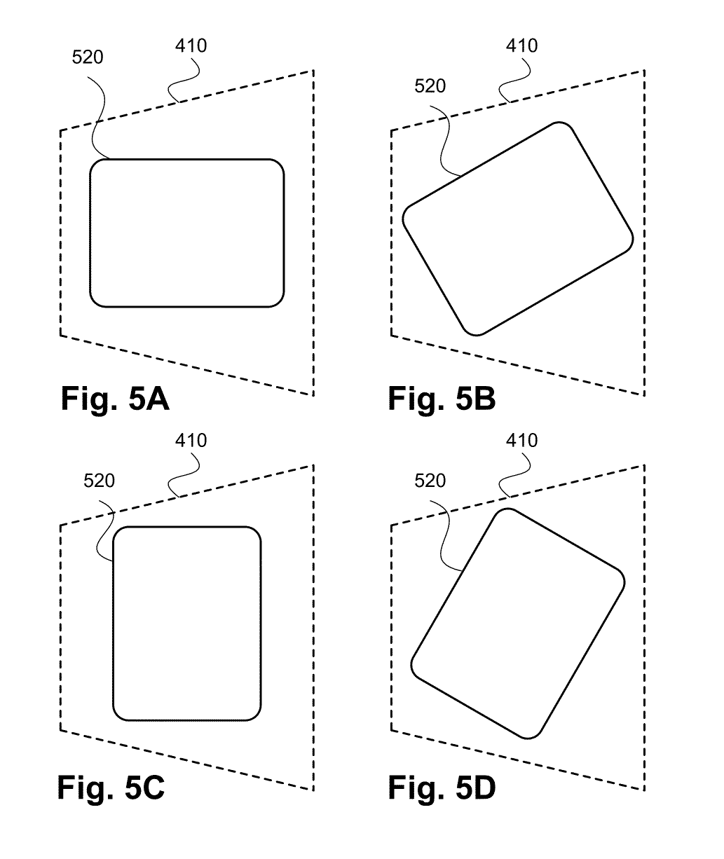

FIGS. 5A to 5D show four possible orientations of visual content 520 displayed in full screen view. It is desirable to calculate the optimal orientation of visual content 520.

### Implementation

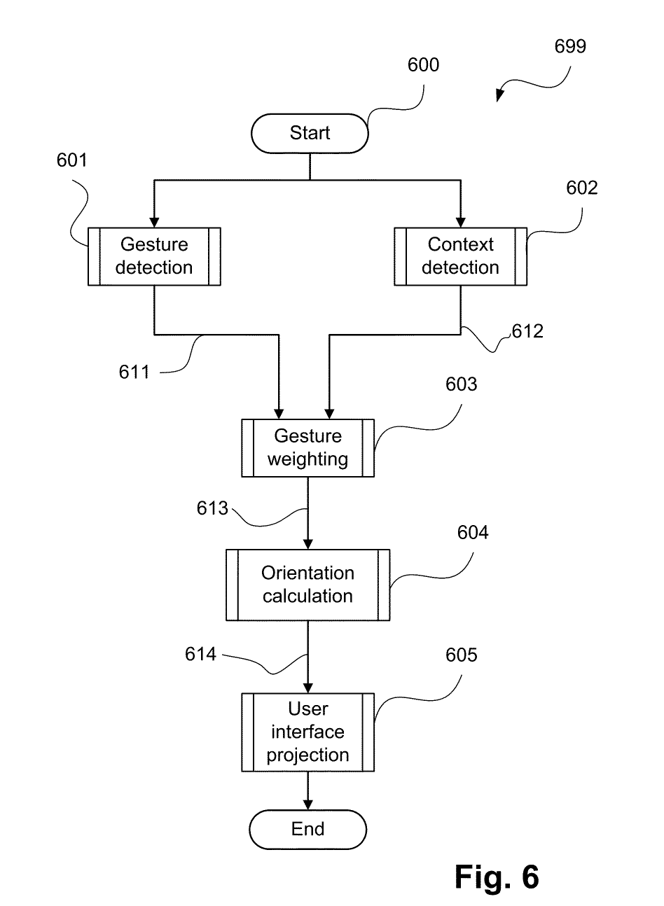

FIG. 6 shows a method 699 for determining an orientation for projecting a user interface 205. The method 699 is executed using CPU 105 of user interface system 100. Processing of the method starts at step 600 each time a full-screen view 520 is displayed. Processing continues, preferably simultaneously, at steps 601 and 602.

At step 601 image data captured by infrared camera 102 is processed to determine gestures of the users to provide gesture information 611. At step 602, context information 612 is determined based on image data acquired by infrared camera 102. Steps 601 and 602 may be performed serially and in either order.

The gesture information 611 and context information 612 are passed to a gesture weighting step 603 to calculate weightings for each of the gestures. The weighted gesture information 613 from the gesture weighting step 603 is then passed to an orientation calculation step 604 that calculates an optimal orientation 614 of the user interface. Finally, a user interface projection step 605 uses the calculated orientation 614 to project the user interface at the appropriate orientation.

Each of these steps 601 to 605 shall be explained in more detail below.

### Gesture—Definition

A gesture is a motion or pose of one or more parts of the body of a user. For example, a detectable gesture is a body gesture and may include a user leaning forward, a person approaching or leaving the user interface, or the proximity of user to the user interface. Gestures may be used to interact with the user interface 205. Gestures may involve a finger gesture or a hand gesture each performing a motion to convey information to the user interface system 100. For example a hand gesture may be used for coarse instruction, such as swiping, whereas fingertip gestures, being a sub-set of hand gestures, may be used for more refined instruction such as pointing and selection. The interpretation of the meaning of a gesture depends on the application and the context. For example, in one application operating in a particular context, motions such as pointing, touching, pinching, swiping, or clapping may be used to indicate highlighting, selection, zooming, progress through a sequence or a wake-up from hibernation, respectively. The same gestures could have different meanings in other applications or in other contexts. Gestures may also be extended from using fingers and hands to include other parts of the body such as arm waving, sitting, standing, approaching, or leaving an area near the user interface 205. Gestures may also be extended to facial expression or eye movement of a user. Depending on the application and context, a smile may mean that a displayed photo is added to the “favourites” folder while a frown may put the photo into a “recycle bin” folder.

In the full-screen view 520, three gestures; pointing, touching and swiping, are detectable. The pointing gesture is interpreted to mean that the user would like to point out and draw attention to a particular part of an image. The system 100 responds to the pointing gesture by displaying a crosshair marker on the image content being pointed to by the finger. The touching gesture is interpreted to mean that the user would like to magnify a particular part of an image. The system 100 responds to the touching gesture by zooming in to the image at the position being touched by the finger. A swipe gesture is interpreted to mean that the user would like to show the next (or previous) image. The system responds to a right-to-left swipe (or left-to-right swipe) by showing the next (or previous) image. Swipes in other directions are preferably ignored.

In a preferred implementation, the system 100 assumes each user may perform one gesture at a time. However, extending the user interface system 100 to allow detection of a user performing two or more gestures at the same time involves performing the gesture detection step 601 in parallel instances for the or each user. How or whether the gesture detection step 601 can be performed in parallel will depend on the processing power of the computer 101 and the speed at which the detection step 601 may be performed.

A special type of gesture, called a “null gesture”, may also be defined. A null gesture is interpreted to indicate that the user did not perform any recognisable gesture. In the preferred implementation, even if the user has performed no gesture, the user is still considered by the system 100 and is taken into account in the calculation of the optimal orientation of the user interface.

### Gesture—Detection Method (General)

There are various techniques for detecting gestures. While the user interface system 100 has been described using an infrared light source 103 and camera 102 to detect a hand of a user and to calculate a distance to the hand, alternative arrangements are possible. Alternative arrangements should be able to locate a hand of a user as well as determine a distance to the hand. An advantage of the user interface system 100 is that the single channel camera system is able to both locate the hand of the user and determine the distance to the hand using the pixel intensity from the IR camera 102.

In an alternative implementation, an RGBD camera may be used to detect gestures. An RGBD camera refers to any item of hardware that captures a two-dimensional array of pixels where each pixel contains red, green, blue and depth channels. The R channel contains the colour intensity of the red colour. The G channel contains the colour intensity of the green colour. The B channel contains the colour intensity of the blue colour. The D channel contains a measure of distance from the camera to an object in the scene corresponding to the pixel. The RGBD camera periodically captures an image, or frame, when a measurement of the hand position and depth may be required. A video sequence of images captured can then be used to track the hand of the user over time. Various object recognition algorithms such as Viola-Jones cascaded Haar-like feature detectors, 3D reconstruction algorithms, and classification algorithms (e.g. hidden Markov models) may be used to detect gestures.

### Gesture—Detection Method (Specific)

A specific implementation detects fingertips in the vicinity of the user interface 205 using the infrared camera 102. The infrared light emitting diode (LED) is used as the light source 103 to illuminate the fingertips as they interact with the user interface 205. The infrared camera 102 and the IR LED 103 are configured in a fixed and known position both relative to each other and in relation to the surface 201 of FIG. 2.

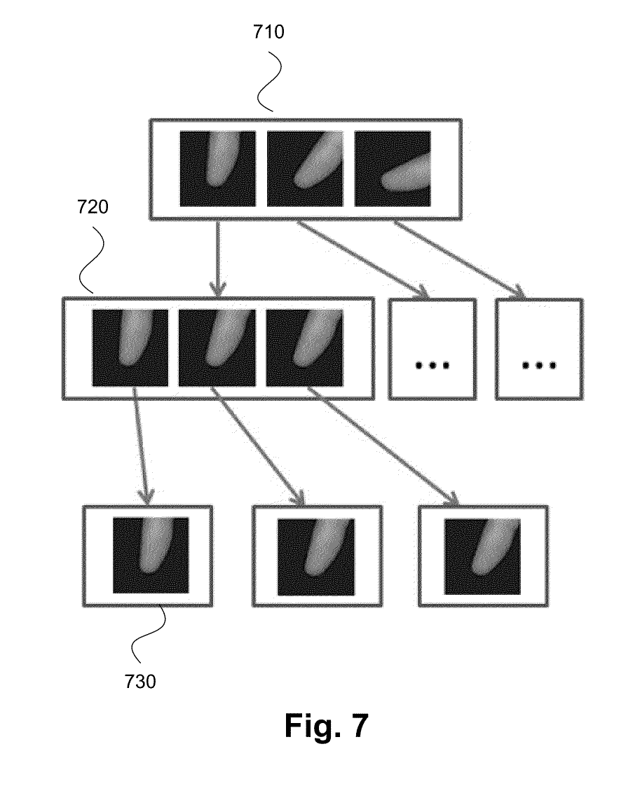

Images of the user interface 205 are captured by the infrared camera 102 and produced as frames at approximately 25 frames per second. For each frame, the gesture detection step 601 executes an algorithm to detect the fingertips in the frame using a Haar-like feature detector. For interaction to occur, fingertips are expected to be on or above the surface 201 within the user interface region 410, seen in FIG. 4 as the trapezoid bounding the icons 420 and 430. This means that the sizes of fingertips appearing in the captured image are expected to be within a predefined range of possible sizes. The window size of the Haar-like feature is defined to be in the range from 24×24 pixels to 120×120 pixels. Because the user can approach the system from all directions, fingertips can appear from a range of angles. Let 0 degrees denote a fingertip approaching perpendicularly to the surface. The system 100 may be configured to detect fingertips at any angle, for example between −50 degrees and +50 degrees. This range of angles has been found by the present inventors to be suitable for the detection of users pointing at objects within the projected GUI. To improve accuracy, in a preferred implementation fingertips are detected through a three-layered hierarchy of Haar-like feature detectors, as shown in FIG. 7, that operate as a training filter. A top layer 710 detector is trained on finger samples on all angles from −50 degrees to +50 degrees, in for example 5 degree increments, only three such samples being illustrated. The top layer 710 serves as a filter that accepts potential fingertip image windows and discards other non-fingertip objects. Each window which passes the top layer detector is then tested against each of a number of subsidiary middle layer detectors 720.

In the example of FIG. 7, there are 5 middle layer detectors, only 3 of which are illustrated:
#1 is trained on finger samples on all angles from −50 degrees to −35 degrees;
#2 is trained on finger samples on all angles from −30 degrees to −15 degrees;
#3 is trained on finger samples on all angles from −10 degrees to +10 degrees;
#4 is trained on finger samples on all angles from +15 degrees to +30 degrees; and
#5 is trained on finger samples on all angles from +35 degrees to +50 degrees.

The middle layer 720 is a subsidiary layer to its parent layer, being the top layer 710 in the present implementation. Each window which passes a middle layer detector 720, is then tested against all the bottom layer detectors 730, associated with the corresponding middle layer detector 720. The bottom layer detectors 730 are subsidiary to a corresponding parent layer detector, being the middle layer detectors 720 in this implementation. In the present implementation, there are 4 or 5 bottom layer detectors 730 under each middle layer detector 720. Each bottom layer detector 730 is trained on finger samples of one specific angle. For example, detector #1 in the middle layer has 4 bottom layer detectors, for angles −50, −45, −40, and −35 degrees.

Furthermore, knowing which specific detector(s) give the strongest match, it is then possible to estimate the orientation angle of the finger. The finger's orientation angle may be estimated by averaging the angles of all detectors that match a finger. This gives an accurate estimate of finger orientation angle—if the angular resolution is finer than 5 degrees.

The arrangement shown in FIG. 7 has 3 layers and variations of 2 or more layers can be implemented depending upon the desired level of accuracy and limitations of processing performance.

Following this, a finger brightness value is calculated for each detected fingertip. The finger brightness value is an average of pixel intensities corresponding to the finger in the vicinity of the detected fingertip. In the present implementation, the finger brightness value is calculated by averaging the 200 brightest pixels within a 40×40 pixel window above the detected fingertip position. A finger brightness value is calculated for each fingertip within each image frame. The finger brightness value is then used to determine the distance of the finger from the camera 102. A mapping from the finger brightness value to distance may be determined using a once-off calibration procedure. The calibration procedure involves positioning an object, such as a finger, at a known position relative to the camera 102 and sampling the brightness of the object within the captured infrared camera image. The process is repeated at several predetermined positions within the field of view of the camera 102. The calibration data is then interpolated across the region of interaction in the vicinity of the graphical user interface 205, thus providing a mapping of object brightness value to distance.

In the preferred implementation, a fingertip distance value is determined for each fingertip detected in the captured image using the average brightness value of the finger and the mapping of finger brightness to distance. A position in 3-dimensional (3D) space is then calculated for each detected fingertip. The infrared camera 102, infrared light source 103 and projector 104 are configured at fixed, known positions and orientations relative to the projection surface 201, for example as facilitated by the housing 202.

One approach is to have prior calibration of the system 100. In a calibration step, a fingertip is placed in multiple 3D positions with known (X, Y, Z) physical coordinates, and the following calibration information is collected: (1) the x pixel coordinate of the fingertip, (2) the y pixel coordinate of the fingertip, and (3) the brightness of the fingertip. The collected calibration information is stored in memory 106. When the user's finger approaches the user interface 205, the system 100 detects the three items of information: x, y pixel coordinates of the fingertip and the brightness of the fingertip. The system 100 then performs an inverse lookup of the calibration data stored in memory 106 and hence finds the closest corresponding 3D position of the fingertip in (X, Y, Z) coordinates. In the present implementation, a convention is used to establish that the Y axis represents the vertical distance from the surface 201. In other words, the surface 201 is, mathematically, the Y=0 plane. As such, a fingertip is considered touching the surface 201 if the Y coordinate of the fingertip is less than 2 mm. The fingertip is pointing when 2 mm<=Y<30 mm.

To detect a swipe gesture, the velocity of each fingertip is determined over a sequence of consecutive frames. A swipe gesture is detected when the velocity of a fingertip exceeds a speed threshold of, for example, 0.75 metres per second. This speed is sufficiently fast to discriminate non-swipe, unintentional or indiscriminate hand movements of users. The speed threshold may be adjusted to accommodate different users, much in the same way mouse clicks may be varied in traditional computer interfaces.

### Gesture—Attributes

A number of additional attributes may be associated with each detected gesture. These attributes may include flags indicating the start and/or end of a gesture, gesture velocity, and gesture orientation angle. Such attribute information provides useful additional detail about a gesture and may provide an insight about an intention of the user. For example, when a user points at an object, in addition to detecting the pointing gesture, it may be valuable to identify what the user is pointing at. The target of a pointing gesture may be determined using ray-casting. A simple ray-casting technique involves determining the 3D position of the fingertip in (X, Y, Z) coordinates and determining a ray through the fingertip position at an angle equal to the orientation angle of the pointing finger. The location where this ray meets the graphical user interface 205 is calculated by projecting the ray on to the Y=0 plane. Gesture attribute information is also used to calculate the weighting of a gesture. For example, a gesture that is performed at a high velocity may be interpreted to indicate the user has a higher urgency of achieving a goal and hence may be assigned a higher weighting.

### Context—Definition

The context detection step 602 detects the context of the user interface 205. Context is information related to the interaction between the users and the user interface system 100. The context of the user interface 205 is characterised by context descriptors that the system is able to recognise. For example, context descriptors may be one or more of the following:
type of content in the user interface, such as presentation slides, photos or documents;
current mode of operation of the user interface, such as presentation mode or editing mode for a presentation application;
expected user roles associated with the content, such as presenter and audience member;
permissions associated with each such role; information about the location of the interaction, such as whether the system 100 is in a small meeting room, or a large conference room;
information about the environment such as date, time, temperature, humidity or compass bearing; the positions of the users; and
the interaction history of the users, including previous gestures and their intentions at the time.

Other possible items may also be included in the set of possible context descriptors.

### Context—Detection (General)

The detection of contextual information will now be explained. Room dimension information may be detected using range imaging devices. The time of day may be retrieved using an Application Programming Interface (API) provided by an operating system running on the computer 101. The illumination within the room may be determined using an ambient light sensor. A user's interaction history may be read from a history buffer in system memory 106 and user intention may be derived from historic events. For example, the intention of editing may be indicated by an earlier touch of an edit button or icon displayed within the user interface 205. Hence, the system 100 can ascertain the current mode of operation, whether that is editing mode or presentation mode.

To detect the context of the user's role, such as the presenter role or the audience role, the system 100 may be configured to assume the user who invoked the application has the presenter role. After system initialisation, the first fingertip detected may be recognised as the user fulfilling the presenter role (the presenter). Subsequent detections of fingertips positioned substantially away from the presenter are recognised as users fulfilling the audience member role (audience members).

Another example of contextual information may include the number of detected users and the spatial clustering (grouping) of users. One important item of context information is position information of the users. FIG. 3 shows five users 301-305 positioned around a user interface 205 centred at a centre position 306, projected by a user interface system 100. Spherical coordinates may be used to represent the position of each user relative to the centre position 306 of the user interface 205. Using spherical coordinates, the position of user k is Pₖ=(rₖ, θₖ, φₖ), ∀k=1 . . . n, where rₖ is radial distance, θₖ is the azimuthal angle, and φₖ is the zenith angle. When projecting on to a horizontal surface, it is likely that the zenith angle has little influence on the orientation of the user interface. For this reason, in the specific implementation being described, the detection of the zenith angle, φₖ, is omitted.

As described above, hardware devices such as optical sensors, omni-directional cameras and range sensors can be used to detect users located in the vicinity of a user interface 205.

### Context—Specific

In preferred implementations, three forms of context information are detected, being: (1) the type of application, either photo previewing or business presentation, (2) the role of the gesturing user, either audience member or presenter, and (3) the locations of each user.

The system 100 can determine the type of content being projected by the user interface from an examination of the filename of the application that is being executed. For example, the filename could be “imagebrowser.exe”, or “powerpoint.exe”. A list of photo previewing application filenames is stored in memory 106. Another list of business presentation application filenames is also stored in memory 106. By searching each list for the application filename, the system 100 can determine the type of application that is being executed.

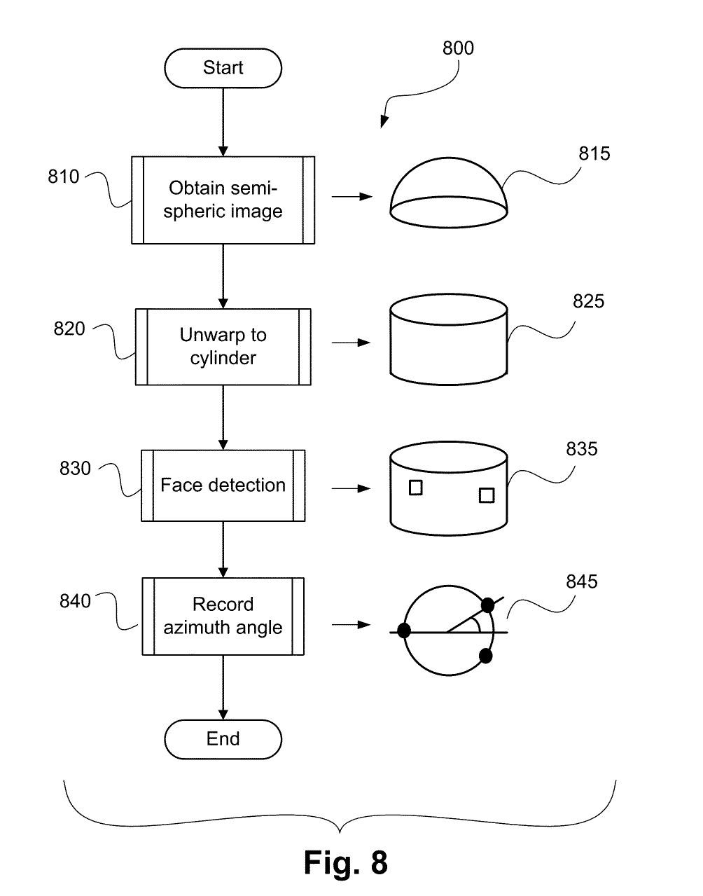

The system 100 then detects the role of the gesturing user, which is either the presenter or an audience member. Using simple rules, the system 100 assumes the first finger that interacted during the current execution of the application is the presenter. Based on the technique depicted in FIG. 7, the system 100 can determine the orientation angle of the finger. The orientation angle of the first finger that interacted with the system is stored in memory 106 as the presenter's finger orientation angle. This stored finger orientation angle is used to identify the presenter's finger. From this time onward, the orientation angle of each detected finger is compared with the orientation angle of the presenter. If the angle of the detected finger is within a threshold, say 5 degrees, of the presenter's finger orientation angle, then gesture of this detected finger is considered to be performed by the presenter. Otherwise, the gesture of this detected finger is considered to be performed by an audience member. The threshold angle may be varied depending on particular presentation circumstances. The system 100 also detects the locations of the users. A user could be someone who has not performed any gestures before. Hence, detecting users based on gestures performed is not an ideal solution. In a preferred implementation, a fisheye lens camera 107 is used to detect user positions. Referring to FIG. 8, a method 800 for detecting each user's location or position relative to the user interface 205 begins at step 810 where an image from a fisheye lens camera 107 is obtained. The objects in the image captured by a fisheye lens camera 107 can be thought of as imaging on the surface of a virtual semi-sphere 815.

A second step 820 in the method 800 is to unwarp the captured image. The image captured in step 810 is a warped image and is the result of projecting points from the fisheye lens through the surface of the virtual semi-sphere 815, and onto the circular wall of a virtual cylinder 825. The calculation of the warping depends on the specifications of the fisheye lens. In the preferred implementation, it is only desired to detect users nearby, for example within 1 metre of the system 100, and approximately 0.2 metre to 1 metre above the desk surface 201. The virtual cylinder 825 that is desired to be projected onto has a radius of 1 metre, centred at the position of the system 100, and the area of interest is between 0.2 metre and 1 metre above the desk surface 201.

To find the mapping between the captured image to the virtual cylinder 825, a marker is placed at a known position where the wall of the virtual cylinder 825 would be. In the preferred implementation, the marker is placed 1 metre away from the fisheye lens camera 107, at the azimuth angle of 9 and h metres above the desk surface, for 0.2<=h<=1. The marker then appears in the captured image at a particular pixel coordinate (x, y). By placing the marker at N various positions, it is possible to store the positions and the corresponding coordinates in a table of (xₖ, yₖ) to (θₖ, hₖ), 1≦k≦N. With a sufficient number of positions, an inverse lookup (mapping) may be constructed from (xₖ, yₖ) to (θₖ, hₖ). This mapping is then used to convert the image captured by the fish eye lens 107 to an image as such would appear on the virtual cylinder wall 825. This process is commonly referred to as projecting a fisheye lens image to a cylinder. The choice of N, the number of positions to place a marker, can be the number of pixels in the captured image. However, it is possible to reduce N by assuming the symmetry and the geometry of the fisheye lens, to thereby derive the data with fewer sample positions.

The third step 830 of the method 800 is to apply face detection on the warped image. Preferably the Viola-Jones algorithm is implemented for face detection, which is similar to implementation of the algorithm described above for fingertip detection. To achieve this, a Viola-Jones classifier would be trained with many images of face to thereby detect faces, as opposed to identify specific faces. The difference is that the wall of the cylinder wraps around when the azimuth angle reaches 360 degrees. In the present implementation, the Viola-Jones algorithm extends the search to include this wrapping region.

The fourth step 840 of the method 100 records the azimuth angle, θₖ of the user's detected face. The azimuth angle corresponds to an angular position on the circumference of the cylinder 825. With this particular implementation, the height, hₖ, which is a vertical position on the height of the cylinder 825 corresponding to the zenith angle, is not of particular concern and is not recorded.

Calculating Weightings from Gestures and Context

Detection information 611 and 612 determined at gesture detection step 601 and context detection step 602 is passed to the gesture weighting step 603, which determines the relative weightings of the detected gestures.

The gesture weighting module at step 603 calculates the relative importance, or weighting, of each detected gesture. Weightings are derived from information detected from the gesture detection step 601 and the context detection step 602. Weightings output from the gesture weighting module at step 603 are then passed to the orientation calculation module 604, which calculates an orientation of the user interface 205 using the gesture weighting.

The gesture weighting step 603 assigns weightings to each gesture in a way that is consistent with the social norms of the users. As an example of a social norm, for the purposes of orienting the user interface 205, users further away from the user interface 205 generally have a lower level of interaction with the user interface 205 than those users in close proximity. This lower level of interaction implies a lower gesture weighting compared to that of a user performing the same gesture at a location closer to the user interface 205. Another example of a social norm is that a salesperson would orientate the user interface 205 to face the customer, even when the salesperson is interacting with the system, as the salesperson's intent is to ensure the customer has an unobstructed view of the displayed information. Social norms vary among different cultures, and social norms may gradually change over time. It is recommended that gesture weighting is manually assigned by, for example, a usability specialist based on the results of prior user studies.

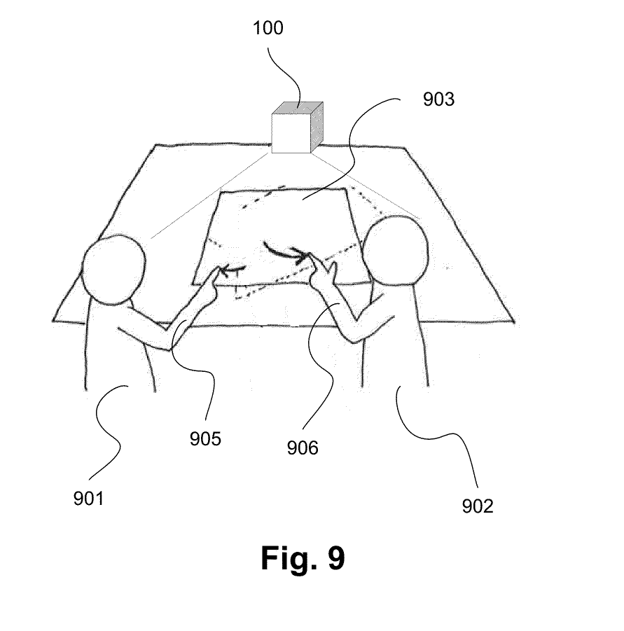

The following is a very simple exemplary scenario, with reference to FIG. 9. Two users, 901, 902, are located at the same distance away from the user interface, 903 formed by the system 100. The two users interact with the interface 903 and the system 100 at the same time. For simplicity, the only context detected is the content type, for example that the user interface system 100 is running a photo previewing application displaying photo content. The user 901 performs a pointing gesture 905 with a particular velocity while the user 902 performs the same pointing gesture 906, but with a higher velocity of finger movement, compared to that of the user 901. Based on prior study of social norms, the gesture weighting module at step 603 should return a higher weighting for the gesture made by user 902, and hence the photo should be oriented more towards the user 902. The weighting reflects the social norm that when previewing photos with friends, an excited friend may “grab” a photo and turn the photo away from another person.

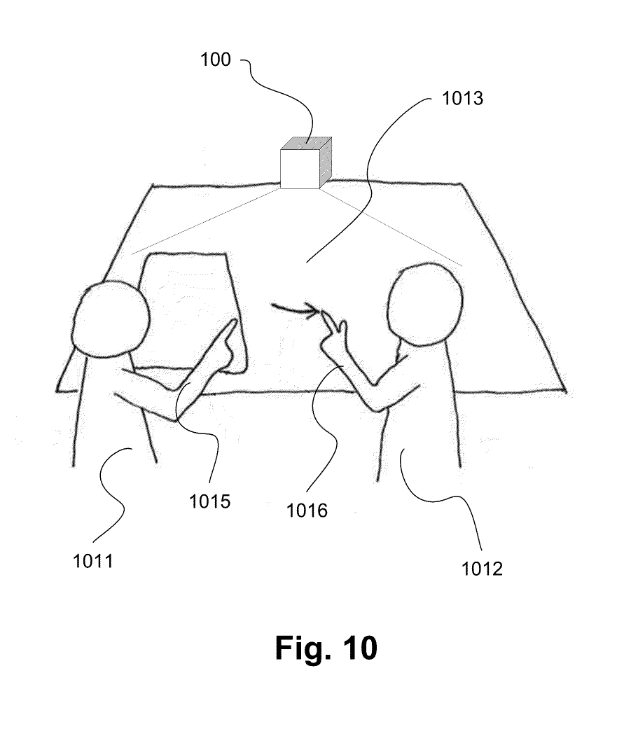

Another example will now be described with reference to FIG. 10. Two users, 1011 and 1012, interact with the system 100 and a user interface 1013 at the same time, performing the same gestures 1015, 1016. However, in this example, the system 100 has detected the interface 1013 is in the context of an editing mode, previously initiated by the user 1011. Because the editing mode is detected, the gesture weighting module at step 603 returns weights W₁=1, W₂=0, indicating that the user interface 1013 should remain oriented towards the first user 1011, who has responsibility of editing.

There are a number of possible methods for calculating gesture weightings, including using decision trees, neural networks, hidden Markov models or, other statistical or machine learning techniques that require prior training.

In one implementation, the system 100 detects pointing, touching, or the null gesture. The system 100 also detects the context of the user interface 205 as a photo preview or business presentation application. The role of the gesturing user is also detected, the role being either the presenter or an audience member. A lookup table of 12 entries, stored in computer memory 106 for assigning the appropriate weighting is shown below in Table 1:

TABLE 1

| Context | Gesture | Role | Weight |
|---|---|---|---|
| photo preview | point | presenter | 0.9 |
| photo preview | point | audience | 0.6 |
| photo preview | touch | presenter | 1 |
| photo preview | touch | audience | 0.8 |
| photo preview | null | presenter | 0.5 |
| photo preview | null | audience | 0.2 |
| business presentation | point | presenter | 0 |
| business presentation | point | audience | 0.7 |
| business presentation | touch | presenter | 0 |
| business presentation | touch | audience | 1 |
| business presentation | null | presenter | 0 |
| business presentation | null | audience | 0.5 |

To determine the weighting, an algorithm executed by the CPU 105, seeks the row of the lookup table where the context matches the detected context, the gesture in the row matches the detected gesture, and the role value in the row matches with the detected role of the user. Once this row of Table 1 is found, the weighting value in that row is output by the gesture weighting step 603. Using Table 1, at step 603 a weighting value is determined for each detected gesture. The determined weighting values, gesture detection information and context detection information form weighted gesture information 613. Following step 603, processing continues at step 604.

### Determining Projection Orientation

The weighted gesture information 613 determined at step 603 is passed to the user interface orientation calculation module at step 604, which determines the appropriate orientation of the user interface 205. The user interface orientation is calculated by combining the weightings of detected gestures, W₁ . . . Wₙ, and the azimuth angles θ₁ . . . θₙ of each user's position around the user interface 205. There are three components to the orientation:
the rotation component R, of the user interface 205,
the translation component T of the user interface 205, and
the scale component s of the user interface 205.

The rotation component R of the user interface 205, is calculated as the weighted average of all the azimuth angles as follows:

$$R = atan 2 ( {\sum }_{k = 1}^{n} {W}_{k} sin ( {θ}_{k} ) , {\sum }_{k = 1}^{n} {W}_{k} cos ( {θ}_{k} ) )$$

$$where$$

$$atan 2 ( y , x ) calculates the arctan of a vector [ \begin{matrix}y \\ x\end{matrix} ] .$$

To avoid unpleasant uttering behaviour, the actual user interface 205 is not rotated when R is similar to the previously calculated value, and rotation is not applied until the value R is stable for a period of time. A filtering technique may be applied to provide for stable rotation of the user interface 205. For example, if the rotation component, R, is considered a time varying signal that is influenced by known or predictable noise characteristics, then a Kalman filter may be used to generate an improved estimate of the underlying signal.

In some situations, such as when a group of users is viewing the user interface 205, it is usually desirable to display a user interface at the largest size that the system 100 will allow. The translation T, and the scale s, are calculated to maximize the area of the user interface 205 for a given rotation R within the physical bounds of the display formed by interaction of the projector 104 and the table surface 201. For a physical display device, for example a tablet computing device, the physical bounds of the display form a rectangle. However, for a projected display, the physical bounds may form a quadrilateral. The shape of the user interface is likely to be rectangular, but it could be generalized to a convex polygon. The values of translation T, and the scale s, are calculated as the solution to a maximal area problem formulated using linear programming, and solved using algorithms like simplex. An alternative is to use a lookup table for the values of T and s for a given R, where R may be quantized to an integer accuracy.

### Projection of the User Interface

The orientation of the user interface 205 is then passed to the user interface projection step 605 to project the user interface at the desired orientation.

Different methods of changing the orientation of the projected user interface 205 may be used. Firstly, the orientation of the user interface 205 may be adjusted with a hardware-system that adjusts the physical projection region. Re-orientation of the user interface 205 may be performed by mechanically adjusting the hardware that projects the user interface onto the surface. For example, a robotic arm may rotate, R, and translate, T, the projector 104. A change of scale, s, is performed by changing the projection distance. In a second example, multiple projectors 104 may be used to achieve a re-orientation with each projector 104 having a different physical projection region. Re-orientation is achieved by enabling one or more of the multiple projectors 104 to display the UI 205.

Secondly, global UI re-orientation involves the entire contents of the user interface 205 being re-oriented within the physical projection region. Here, the pixels of the projected user interface 205 are effectively redrawn at a new orientation and projected. For example, the entire user interface 205 may need to be rotated by 180 degrees to allow a group of people to interact with the user interface 205 from the opposite side of a desk surface 201. This re-orientation may be achieved by rotating the entire user interface contents 180 degrees while the physical projection region is fixed. Global UI re-orientation may be achieved by applying an affine transformation to the entire UI contents. Note that at a given rotation, R, due to the limited physical projection region of the projector 104, the user interface 205 may need to be scaled and/or translated to fit within the physical projection region.

Thirdly, UI element re-orientation involves re-orienting a specific element or elements of the user interface 205. For example, an application may allow many photos to be projected on a surface for viewing by an audience. A member of the audience may perform a gesture to view a selected photo in closer detail. The selected photo is re-oriented towards the audience member while other photos remain in their existing orientations.

A particular re-orientation may involve simultaneous hardware-based, global UI and UI element re-orientations. The user interface projection module at step 605 determines the necessary hardware-based, global UI and UI element re-orientations and projects the user interface 205 at the desired orientation. Achieving a particular hardware re-orientation may involve generating hardware signals on a communications line to instruct a robotic arm to reposition a projector. Further achieving a particular global UI re-orientation may involve rotating a pixel image using an anti-aliasing rotation algorithm after the graphical user interface has been rendered to pixel image form and before projection by the projector 104. Achieving a particular UI element re-orientation may also involve an affine transformation being applied to a particular UI element prior to rendering the graphical user interface to pixel image form.

Some implementations of the system 100 utilise only a single, fixed projector. Such implementations are limited to global UI and UI element means of orientation. Implementations with more than one projector, or at least one physically manipulable projector, offer greater flexibility of UI and element orientation.

Display of the user interface 205 may be realised using a variety of techniques. Such techniques include any form of projection using one or multiple projectors, or, display on one or multiple display panels (for example, liquid crystal display panels), large or small in size. The user interface 205 may be displayed on vertical, horizontal, or curved surfaces, flat or non-flat surfaces, or within a volume in 3D space. The user interface 205 may be displayed using any combination of aforementioned techniques.

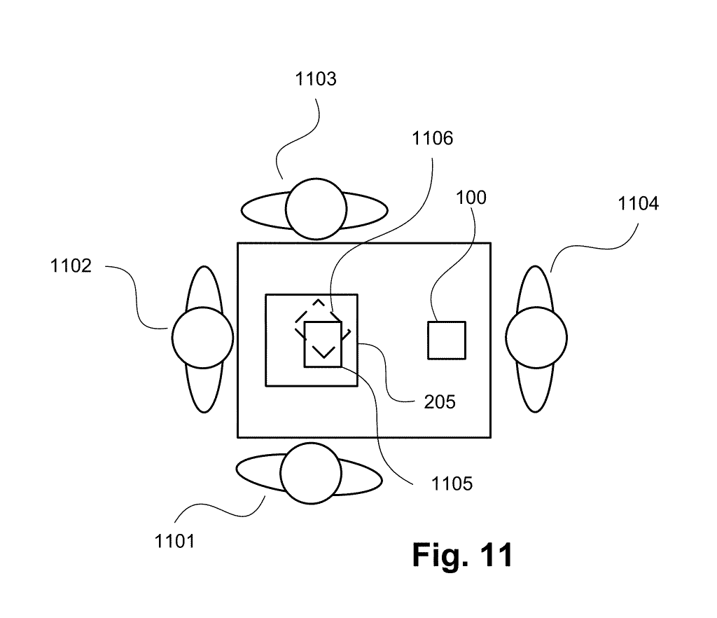

Consider the scenario of photo previewing in FIG. 11, where a presenter 1104 is showing photos to three (3) friends using the system 100 and the user interface 205. The presenter 1104 is positioned at 0 degrees to the user interface 205. The three friends are sitting at 90 degrees 1103, 180 degrees 1102 and 270 degrees 1101 relative to the user interface 205. Accordingly, the azimuth angles of the four users are 0, 90, 180, and 270. In this example, initially none of the users are performing a gesture (i.e. the gesture is considered to be “null”). Rows of the lookup table (Table 1) are used to determine weightings for each gesture. The relevant rows of the lookup table (Table 1) are shown in Table 2 below:

TABLE 2

| | | | |
|---|---|---|---|
| photo preview | null | presenter | 0.5 |
| photo preview | null | audience | 0.2 |

Accordingly, the system 100 determines the weightings of the four participants 1104, 1103, 1102 and 1101 as 0.5, 0.2, 0.2, and 0.2 respectively. With the equation:

R=a tan 2(Σₖ₌₁ⁿWₖ sin(θₖ),Σₖ₌₁ⁿWₖ cos(θₖ))

the initial rotation angle R, is calculated to be zero degrees, i.e. facing the presenter, as expected by social norms. In another example, the friend at 90 degrees 1103 points at the photo 1105, while other users 1102, 1101, 1104 are not performing gestures. The relevant rows from the lookup table (Table 1) are shown in Table 3 below:

TABLE 3

| | | | |
|---|---|---|---|
| photo preview | point | audience | 0.6 |
| photo preview | null | presenter | 0.5 |
| photo preview | null | audience | 0.2 |

Accordingly, the system 100 determines new weightings for the four participants 1104, 1103, 1102 and 1101 to be 0.5, 0.6, 0.2, and 0.2 respectively. The rotation angle calculation returns R=53.1 degrees. Changing the orientation of the photo 1105 to 53.1 degrees rotates the photo 1105 to a new position 1106 approximately in the middle between the presenter 1104 and the friend who pointed at the photo 1103. This arrangement is within the expectations of social norms.

It will be noted that in each of the above examples, the sum of the various weightings is not equal to 1.0. In this respect, the arrangements presently described do not rely upon strict mathematical calculations for the interpretation of gestures as it is the relative difference of weight applied to detected gestures that is important. In this fashion the arrangements presently described can accommodate a range of participant numbers, particularly where there may be one or two “presenters” and any number of “audience”. For example one presenter and one audience, or two presenters and eight audience.

The value of translation T, and the scale s, is then calculated to maximize the size of the user interface 205.

As stated above, the rotation of the photo does not occur immediately. The system 100 only starts the rotation when the value of R is within the same 5 degree interval for the most recent 20 frames. The duration of the rotation is 3 seconds, similar to the duration of passing a photo to a friend in the current social norm.

### INDUSTRIAL APPLICABILITY

The arrangements described are applicable to the computer and data processing industries and particularly for the presentation of user interfaces.

The foregoing describes only some embodiments of the present invention, and modifications and/or changes can be made thereto without departing from the scope and spirit of the invention, the embodiments being illustrative and not restrictive.

We claim:

1. A method of projecting a user interface for a plurality of users with a calculated orientation, the method comprising:
detecting gestures from the plurality of users associated with a projection of the user interface;
applying a weighting, representing a level of interaction between a user and the user interface, to each of the detected gestures according to a gesture type and a context of the user interface when the gesture was detected, the context including consideration of positions of the plurality of users;
calculating an orientation of the user interface based on the weighting of the detected gestures and the context of the user interface; and
projecting the user interface for the plurality of users with the calculated orientation.

2. A method according to claim 1, wherein the gesture type is a hand gesture.

3. A method according to claim 1, wherein the gesture type is a body gesture.

4. A method according to claim 3 wherein the body gesture is one of a user leaning forward, person approaching or leaving the user interface, proximity of user to the user interface.

5. A method according to claim 1, wherein the gesture type is a “null gesture” representative of the presence of a user who is not detected to perform a recognisable gesture.

6. A method according to claim 2 wherein the hand gesture comprises a fingertip gesture detected using a multi-layer training filter to ascertain an angle of the fingertip gesture.

7. A method according to claim 6 wherein the multi-layer training filter comprises a top layer that discriminates potential fingertip images from non-fingertip images.

8. A method according to claim 7 wherein the multi-layer training filer comprises at least one subsidiary layer having a plurality of fingertip images each associable with one potential fingertip image of the corresponding parent layer.

9. A method according to claim 1, wherein the context of the user interface is determined from at least one of:
(i) content being presented by the user interface;
(ii) a role of each user of the user interface; and
(iii) a position of each user associated with the user interface.

10. A method according to claim 9, wherein positions of users of the user interface are determined relative to a centre of the user interface using spherical coordinates.

11. A method according to claim 9, wherein a position of a user is determined using face detection within an image captured by a camera associated with the detecting.

12. A method according to claim 9, wherein the content is determined from a filename of an application being executed and reproduced by the user interface.

13. A method according to claim 12, wherein a role of a user is determined from one of a presentation mode or an editing mode associated with the application being executed and reproduced by the user interface.

14. A method according to claim 13 further comprising identification of the editing mode to assign a presenter role to at least one user and an audience role to at least one other user.

15. User interface apparatus comprising:
a computer having processor coupled to a memory, the memory storing a program executable by the processor to form a user interface by which plurality of users can interact with the interface;
at least one projector coupled to the computer configured to project an image of the user interface onto a surface;
at least one camera coupled to the computer and configured to detect gestures from the plurality of users associated with the image of the user interface;
the program comprising:
code for applying a weighting, representing a level of interaction between a user and the user interface, to each of the detected gestures according to a gesture type and a context of the user interface when the gesture was detected, the context including consideration of positions of the plurality of users;
code for calculating an orientation of the user interface based on the weighting of the detected gestures and the context of the user interface; and
code for causing the projector to project the user interface for the plurality of users with the calculated orientation.

16. User interface apparatus according to claim 15 wherein the camera is an infrared camera, the apparatus further comprising an infrared light source for illuminating a projection area of the surface with infrared light for detection by the infrared camera in concert with interaction with the users.

17. User interface apparatus according to claim 15, further comprising at least one device configured to detect the context, said device including at least one of a range sensors, a light sensors, an omni-directional cameras, a microphone, a LIDAR device, and a LADAR devices, the context of the user interface being determined from at least one of:
(i) content being presented by the user interface;
(ii) a role of each user of the user interface; and
(iii) a position of each user associated with the user interface; and wherein positions of users of the user interface are determined relative to the centre of the user interface using spherical coordinates of a face detected within an image captured by the camera.

18. User interface apparatus according to claim 17, wherein the content is determined from a filename of an application being executed and reproduced by the user interface and a role of a user is determined from one of a presentation mode or an editing mode associated with the application being executed and reproduced by the user interface, and identification of the editing mode to assign a presenter role to at least one user and an audience role to at least one other user.

19. User interface apparatus according to claim 15 further comprising a robotic arm coupled to the computer and upon which the projector is mounted, the robotic arm being controllable by the computer to cause the projectors to project the user interface for the plurality of users with the calculated orientation.

20. User interface apparatus according to claim 15 wherein the gesture type is at least one a hand gesture, a body gesture, and a null gesture representative of the presence of a user who is not detected to perform a recognisable gesture, wherein the hand gesture comprises a fingertip gesture detected using a multi-layer training filter to ascertain an angle of the fingertip gesture, the multi-layer training filter comprising a top layer that discriminates potential fingertip images from non-fingertip images and at least one subsidiary layer having a plurality of fingertip images each associable with one potential fingertip image of the corresponding parent layer.
